(19) United States
(12) Patent Application Publication
(10) Pub. No.: US 2026/0184578 A1
(43) Pub. Date: Jul. 2, 2026

(54) SILICA AEROGEL AND AGING AND DRYING METHOD THEREOF

(71) Applicant: Ping Gong, Jinan City (CN)

(72) Inventor: Ping Gong, Jinan City (CN)

(21) Appl. No.: 19/174,319

(22) Filed: Apr. 9, 2025

(30) Foreign Application Priority Data
Dec. 26, 2024 (CN) 202411941926.0

(51) Int. Cl. C01B 33/158; C01B 33/154; C01B 33/159

(52) U.S. Cl. CPC C01B 33/1585; C01B 33/154; C01B 33/159; C01P 2004/03; C01P 2006/12; C01P 2006/14; C01P 2006/32

(57) ABSTRACT

Provided are a silica aerogel and an aging and drying method thereof. An aging and drying method for a silica aerogel includes: providing a silica sol-gel solution; subjecting the silica sol-gel solution to a first aging to obtain a wet gel, where the first aging is conducted for 24-48 hours; and arranging an organic solvent protective layer on a surface of the wet gel, subjecting a resulting system to a second aging, and drying to obtain the silica aerogel, where the second aging is conducted for greater than 168 hours.

### CROSS REFERENCE TO RELATED APPLICATION

This patent application claims the benefit and priority of Chinese Patent Application No. 2024119419260 filed with the China National Intellectual Property Administration on Dec. 26, 2024, the disclosure of which is incorporated by reference herein in its entirety as part of the present application.

### TECHNICAL FIELD

The present disclosure relates to the technical field of fabrication of new materials, in particular to a silica aerogel and an aging and drying method thereof.

### BACKGROUND

Aerogel is a material with a nanoporous structure, and its solid phase and pore structure are nanoscale. Aerogel usually consists of colloidal particles or polymer molecules coalescing with each other to form a nanoporous network structure, and is filled with gaseous disperse media in pores. Aerogels can be divided into three categories: inorganic aerogels, organic aerogels and carbon aerogels according to skeleton composition. Main types of the inorganic aerogels include silicon aerogels and metal oxide aerogels; precursors used in the organic aerogels are mostly resorcinol-formaldehyde; and the carbon aerogels are obtained by retaining only carbon skeleton structure of carbonized organic aerogels under inert atmosphere and at a high temperature.

In the prior art, the aerogels are usually obtained by supercritical drying of a wet gel. In a sol-gel solution preparation process, by controlling hydrolysis and polycondensation conditions of a solution, nanoclusters with different structures are formed in the solution. The clusters adhere to each other to form a gel, while a solid skeleton of the gel is filled with residual liquid reagents after chemical reaction. These residual liquid reagents have surface tension on the solid skeleton of the gel. In the subsequent drying process, the surface tension in micropores of the solid skeleton will lead to destruction of the solid skeleton of the aerogel, failing to form an aerogel with a continuous network structure.

### SUMMARY

The present disclosure is intended to provide a silica aerogel and an aging and drying method thereof. The aging and drying method for the silica aerogel provided by the present disclosure will not destruct a solid skeleton in a wet silica gel, and could be fabricated into a silica aerogel with a continuous network structure.

To achieve the above objects, the present disclosure provides the following technical solutions.

Provided is an aging and drying method for a silica aerogel, including:
providing a silica sol-gel solution;
subjecting the silica sol-gel solution to a first aging to obtain a wet gel, where the first aging is conducted for 24-48 hours; and
arranging an organic solvent protective layer on a surface of the wet gel, subjecting a resulting system to a second aging, and drying to obtain the silica aerogel, where the second aging is conducted for greater than 168 hours.

In some embodiments, an organic solvent in the organic solvent protective layer includes one selected from the group consisting of ethanol and acetone.

In some embodiments, a thickness of the organic solvent protective layer is 5-15 mm higher than an upper surface of the wet gel.

In some embodiments, the first aging and the second aging each are conducted at a temperature of 20-50° C.

In some embodiments, the drying is conducted at a temperature of 100-180° C. for 3-24 hours.

In some embodiments, further includes, after the second aging, subjecting a resulting aged product to hydrophobic modification, and subjecting a resulting hydrophobic modified product to the drying to obtain a hydrophobic silica aerogel.

In some embodiments, a reagent for the hydrophobic modification includes one selected from the group consisting of trimethylchlorosilane and hexamethyldisilazane.

In some embodiments, the hydrophobic modification includes: immersing the resulting aged product in a hydrophobic modification reagent, and conducting the hydrophobic modification for 4-6 hours.

The present disclosure further provides a silica aerogel fabricated by the aging and drying method described in the above technical solutions.

The present disclosure further provides an aging and drying method for a silica aerogel, including: providing a silica sol-gel solution; subjecting the silica sol-gel solution to a first aging to obtain a wet gel, where the first aging is conducted for 24-48 hours; and arranging an organic solvent protective layer on a surface of the wet gel, subjecting a resulting system to a second aging, and drying to obtain the silica aerogel, where the second aging is conducted for greater than 168 hours. In the present disclosure, arranging the organic solvent protective layer on the surface of the wet silica gel could prevent the surface of the wet silica gel from drying during subsequent aging, causing liquid surface tension in micropores of a solid skeleton to destruct the solid skeleton that has not been fully reinforced. Moreover, the second aging in the present disclosure is controlled at greater than 168 hours. In this aging process, the solid skeleton in the wet silica gel is continuously reinforced to ensure that the surface tension formed by residual liquid reagents in the solid skeleton does not lead to destruction of the solid skeleton during drying, obtaining a porous, disordered and low-density silica aerogel with a nanoscale continuous network structure.

### BRIEF DESCRIPTION OF THE DRAWINGS

To describe the technical solutions in the embodiments of the present disclosure or in the prior art more clearly, the drawings required for the examples will be briefly described below. Apparently, the drawings in the following description show merely some embodiments of the present disclosure, and those of ordinary skill in the art may still derive other drawings from these drawings without creative efforts.

FIGS. 1 and 2 show scanning electron microscope (SEM) images of the silica aerogel fabricated in Example 1 at a scale of 200 nm;

FIGS. 3 and 4 show SEM images of the silica aerogel fabricated in Example 2 at a scale of 200 nm;

FIGS. 5 and 6 show SEM images of the silica aerogel fabricated in Example 3 at a scale of 200 nm; and

FIG. 7 shows an SEM image of the silica aerogel fabricated in Example 3 at a scale of 100 nm.

### DETAILED DESCRIPTION OF THE EMBODIMENTS

The present disclosure provides an aging and drying method for a silica aerogel, including:
providing a silica sol-gel solution;
subjecting the silica sol-gel solution to a first aging to obtain a wet gel, where the first aging is conducted for 24-48 hours; and
arranging an organic solvent protective layer on a surface of the wet gel, subjecting a resulting system to a second aging, and drying to obtain the aerogel, where the second aging is conducted for greater than 168 hours.

In some embodiments of the present disclosure, unless otherwise specified, all raw materials for fabrication are commercially available products well known to those skilled in the art.

In the present disclosure, a method for preparing a silica sol-gel solution includes: mixing a silicon precursor, an organic solvent, an acid reagent, and an alkali reagent to obtain a mixture, subjecting the mixture to a reaction to obtain the silica sol-gel solution.

In the present disclosure, the silicon precursor includes one selected from the group consisting of tetraethyl orthosilicate and tetramethyl orthosilicate, and may be the tetraethyl orthosilicate in specific embodiments. The organic solvent include ethanol, acetone, etc., and may be the ethanol in specific embodiments. The acid reagent is hydrochloric acid; the hydrochloric acid is at pH 2.3-5, and may be pH 3 or pH 4 in specific embodiments. The alkali reagent is composed of aqueous ammonia and ethanol. A ratio of the aqueous ammonia to the ethanol is in a range of 1: (40-70), and may be 1:50 or 1:60 in specific embodiments.

In the present disclosure, a ratio of the silicon precursor, the organic solvent, and the acid reagent may be 1:4:4. A quantity of the alkali reagent is 25-35% of a total weight of the silicon precursor, the organic solvent, and the acid reagent, and may be 30% in specific embodiments.

In the present disclosure, the tetraethyl orthosilicate, absolute ethanol are mixed and stirred with water, and a resulting mixture is subjected to hydrolysis, as shown in formula I:

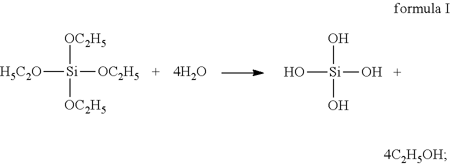

and
an active monomer (hydroxyl-polar group) is generated by the above hydrolysis, and the hydroxyl group is polymerized, as shown in formula II:

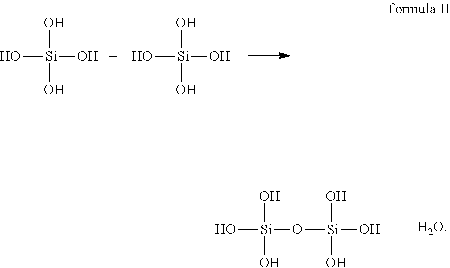 [SMILES: O[Si](O)(O)O ; O[Si](O)(O)O ; O[Si](O)(O)O[Si](O)(O)O ; "H2O."]

The hydroxyl groups are polymerized to form a sol, and the silica sol-gel solution with a specific spatial structure is generated through a two-step acid-alkali catalysis.

The present disclosure further includes modification of the silica sol-gel solution; a reagent for the modification is N,N-dimethylformamide; the reagent for the modification accounts for 0.3-0.6% of a mass of the silica sol-gel solution, and may account for 0.5% of the mass of the silica sol-gel solution in specific embodiments. There are no specific limitations on conditions of the modification in the present disclosure. In the present disclosure, the silica sol-gel solution is modified with N,N-dimethylformamide, contributing to formation of a silicon chain (hydroxyl polymer) with a solid skeleton, and to liquid separation in micropores of the solid skeleton.

In the present disclosure, a first aging is conducted on the silica sol-gel solution to obtain a wet gel; the first aging is conducted for 24-48 hours. In the present disclosure, the first aging is conducted at a temperature of 20-50° C., and may be 25° C., 35° C., or 40° C. in specific embodiments; the first aging is conducted for 24-48 hours, and may be conducted for 36 hours or 40 hours in specific embodiments. In the present disclosure, the wet gel may be obtained by the first aging, so as to cover the wet gel with an organic solvent protective layer to prevent a surface of the wet gel from drying during a second aging.

In the present disclosure, an organic solvent in the organic solvent protective layer includes one selected from the group consisting of ethanol and acetone, and may be the ethanol in specific embodiments. The ethanol is absolute ethanol. A thickness of the organic solvent protective layer is 5-15 mm higher than an upper surface of the wet gel. In specific embodiments, the thickness may be 5 mm, 8 mm, or 10 mm. In the present disclosure, arranging the organic solvent protective layer on the surface of the wet gel could prevent the surface of the wet gel from drying during the subsequent aging, thereby preventing liquid surface tension in the micropores of the solid skeleton from destructing the solid skeleton.

In the present disclosure, the second aging is conducted at a temperature of 20-50° C., and may be conducted at 25° C., 35° C., or 40° C. in specific embodiments; the second aging is conducted for greater than 168 hours, may be conducted for 200-2,000 hours, and may be conducted for 200 hours, 300 hours, 600 hours, 1,000 hours or 2,000 hours in specific embodiments.

In the present disclosure, the drying is conducted at a temperature of 100-180° C., and may be conducted at 120° C., 150° C., or 160° C. in specific embodiments. The drying is conducted for 3-24 hours, and may be conducted for 5 hours or 12 hours in specific embodiments. Means of the drying may be selected from the group consisting of air-drying, oven-drying and negative pressure microwave.

In the present disclosure, after the second aging, a resulting aged product is directly dried, and a resulting aerogel is a hydrophilic silica aerogel.

In the present disclosure, further includes, after the second aging, subjecting the resulting aged product to hydrophobic modification, and subjecting a resulting hydrophobic modified product to the drying to obtain a hydrophobic silica aerogel.

In the present disclosure, a reagent for the hydrophobic modification includes trimethylchlorosilane; the trimethylchlorosilane is used in a form of a trimethylchlorosilane solution; a solvent of the trimethylchlorosilane solution is n-hexane; a volume ratio of the trimethylchlorosilane to the n-hexane is in a range of 1: (7-10), and may be 1:9 in specific embodiments.

In the present disclosure, the hydrophobic modification includes the following step: immersing the resulting aging product in a hydrophobic modification reagent; the hydrophobic modification reagent immerses an aged product colloid by 3-20 mm, and by 5 mm or 10 mm in specific embodiments.

In the present disclosure, the hydrophobic modification is conducted at a temperature of 20-50° C. for 4-12 hours, and may be conducted for 6 hours in specific embodiments.

The present disclosure further provides a silica aerogel fabricated by the aging and drying method described in the above technical solutions.

In order to further illustrate the present disclosure, a silica aerogel and an aging and drying method thereof provided by the present disclosure will be described in detail below in conjunction with drawings and examples, but they should not be construed as limiting the scope of the present disclosure.

### Example 1

Tetraethyl orthosilicate, absolute ethanol and dilute hydrochloric acid with a pH value of 3 were mixed in a ratio of 1:4:4 by stirring for 15 min, and then stirred with a 1:50 mixture of aqueous ammonia and absolute ethanol as an alkali reagent for 60 min to obtain a silica sol-gel solution.

The silica sol-gel solution with a thickness of 20 mm was poured into a container and covered with a lid, placed at a temperature of 20-50° C., and aged for 48 hours to obtain a wet silica gel.

The container containing the above wet silica gel was uncovered, and absolute ethanol was added to an upper surface of the gel to make the absolute ethanol completely cover the gel, which was 10 mm higher than the upper surface of the gel. The lid of the container containing the gel was covered, and the gel was aged at a temperature of 20-50° C. for 600 hours. The container containing an aged wet silica gel was uncovered, and residual absolute ethanol was poured out, without covering the lid again; then the container containing the aged wet silica gel was placed in a high-temperature drying oven and dried at 120° C. for 3 hours to obtain a hydrophilic silica aerogel.

### Example 2

Tetraethyl orthosilicate, absolute ethanol and dilute hydrochloric acid with a pH value of 3 were mixed in a ratio of 1:4:4 by stirring for 15 min, and then stirred with a 1:50 mixture of aqueous ammonia and absolute ethanol as an alkali reagent for 60 min to obtain a silica sol-gel solution.

The silica sol-gel solution with a thickness of 20 mm was poured into a container and covered with a lid, placed at a temperature of 20-50° C., and aged for 48 hours to obtain a wet silica gel.

The container containing the above wet silica gel was uncovered, and absolute ethanol was added to an upper surface of the gel to make the absolute ethanol completely cover the gel, which was 10 mm higher than the upper surface of the gel. The lid of the container containing the gel was covered, and the gel was aged at a temperature of 20-50° C. for 600 hours. The container containing an aged wet silica gel was uncovered, and residual absolute ethanol was poured out. A 1:9 (v/v) mixture of trimethylchlorosilane and n-hexane was added to the container. The mixture immersed the aged wet silica gel by 3 mm, and then the container was immediately covered with a lid for sealing. A reaction was carried out at a temperature of 20-50° C. for 6 hours. The container was uncovered, a residual liquid was poured out, and absolute ethanol was poured into the container to immerse a hydrophobically modified wet silica gel by 3 mm, followed by soaking for 24 hours. The container containing the hydrophobically modified wet silica gel was uncovered, and residual absolute ethanol was poured, without covering the lid again; then the container containing the hydrophobically modified wet silica gel was placed in a high-temperature drying oven and dried at 120° C. for 3 hours to obtain a hydrophobic silica aerogel.

### Example 3

Tetraethyl orthosilicate, absolute ethanol and dilute hydrochloric acid with a pH value of 3 were mixed in a ratio of 1:4:4 by stirring for 15 min, and then stirred with a 1:50 mixture of aqueous ammonia and absolute ethanol as an alkali reagent for 60 min to obtain a silica sol-gel solution.

The silica sol-gel solution with a thickness of 20 mm was poured into a container and covered with a lid, placed at a temperature of 20-50° C., and aged for 48 hours to obtain a wet silica gel.

The container containing the above wet silica gel was uncovered, and absolute ethanol was added to an upper surface of the gel to make the absolute ethanol completely cover the gel, which was 10 mm higher than the upper surface of the gel. The lid of the container containing the gel was covered, and the gel was aged at a temperature of 20-50° C. for 600 hours. The container containing an aged wet silica gel was uncovered, and residual absolute ethanol was poured out, without covering the lid again; then the container containing the aged wet silica gel was placed in dry sunlight (i.e., at ambient humidity of less than 30%) and sun-dried at a temperature above 20° C. for 24 hours (intermittent in the middle of the sun-drying) to obtain a hydrophilic silica aerogel.

### Test Example

The silica aerogels fabricated in Examples 1 to 3 were characterized under a 400,000×scanning electron microscope (SEM). Results are as follows:

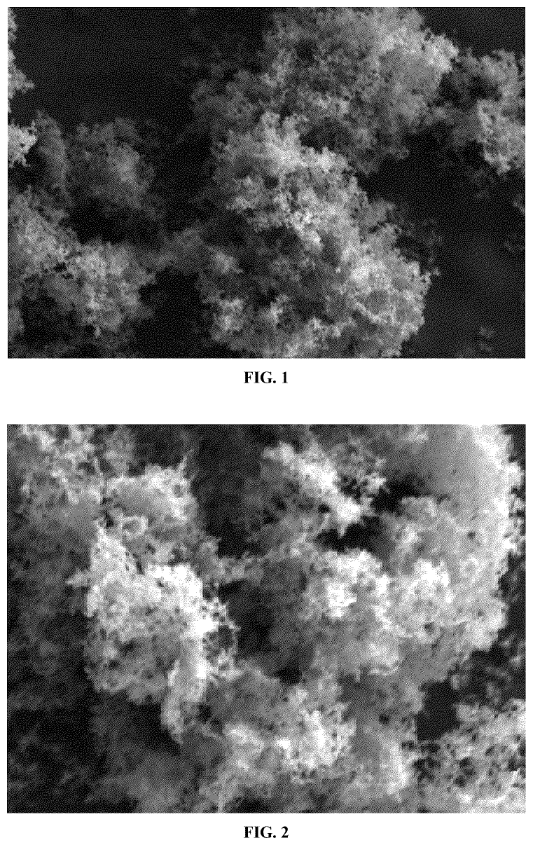

FIGS. 1 and 2 show SEM images of the silica aerogel fabricated in Example 1 at a scale of 200 nm;

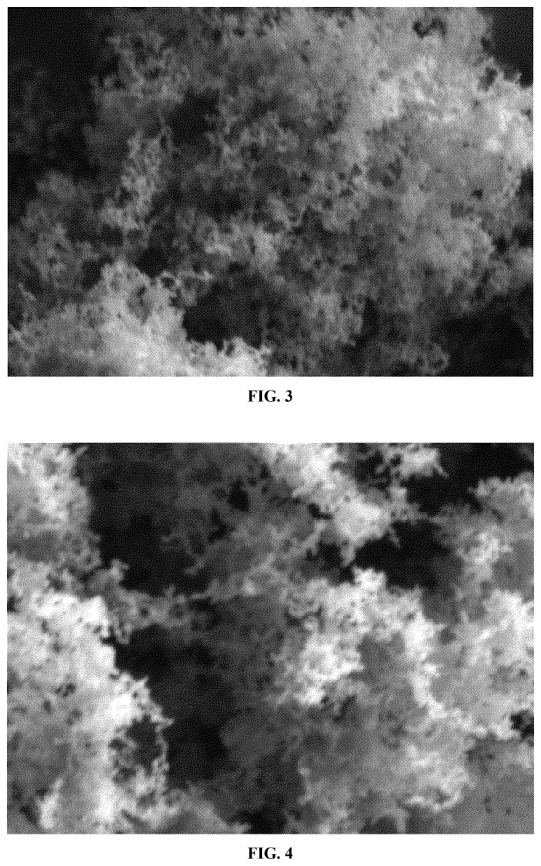

FIGS. 3 and 4 show SEM images of the silica aerogel fabricated in Example 2 at a scale of 200 nm;

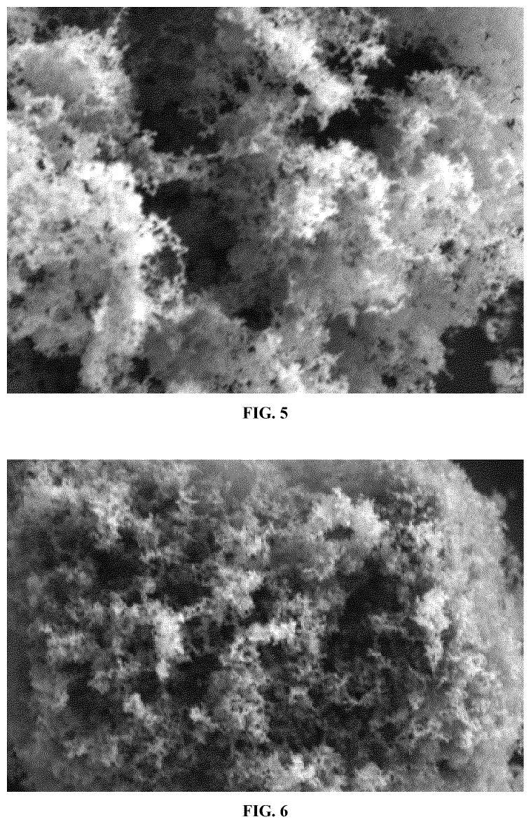

FIGS. 5 and 6 show SEM images of the silica aerogel fabricated in Example 3 at a scale of 200 nm; and

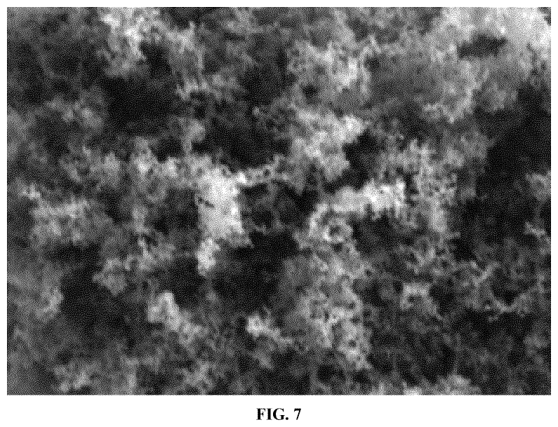

FIG. 7 shows an SEM image of the silica aerogel fabricated in Example 3 at a scale of 100 nm.

From FIGS. 1 to 7, it can be seen that an aerogel fabrication process in the present disclosure avoids destruction of a network structure of a solid skeleton of the silica gel during drying, and a low-density silica aerogel with a nanoscale continuous network structure is fabricated.

The performances of the silica aerogels fabricated in Examples 1 to 3 were tested. Results are shown in Table 1 below.

TABLE 1
The performance test results of the silica aerogels fabricated in Examples 1 to 3

| | | Specific | | | Pore | Thermal |
|---|---|---|---|---|---|---|
| | Density | surface area | Porosity | Aperture | volume | conductivity |
| Source | (kg/m³) | (m²/g) | (%) | (nm) | (mL/g) | (w/m · k) |
| Example 1 | 100 | 700 | 95 | 13-15 | 3.5 | 0.013 |
| Example 2 | 60 | 910 | 97 | 30-50 | 3.7 | 0.012 |
| Example 3 | 80 | 830 | 95 | 20-35 | 3.7 | 0.013 |

According to the results of Table 1, the silica aerogel fabricated by the present disclosure is a porous, disordered and low-density silica aerogel with a nanoscale continuous network structure.

Although the present disclosure is described in detail in conjunction with the foregoing embodiments, they are only only a part of, not all of, the embodiments of the present disclosure. Other embodiments can be obtained by persons based on these embodiments without creative efforts, and all of these embodiments shall fall within the scope of the present disclosure.

What is claimed is:

1. An aging and drying method for a silica aerogel, comprising:
providing a silica sol-gel solution;
subjecting the silica sol-gel solution to a first aging to obtain a wet gel, wherein the first aging is conducted for 24-48 hours; and
arranging an organic solvent protective layer on a surface of the wet gel, subjecting a resulting system to a second aging, and drying to obtain the silica aerogel, wherein the second aging is conducted for greater than 168 hours.

2. The aging and drying method of claim 1, wherein an organic solvent in the organic solvent protective layer comprises one selected from the group consisting of ethanol and acetone.

3. The aging and drying method of claim 1, wherein a thickness of the organic solvent protective layer is 5-15 mm higher than an upper surface of the wet gel.

4. The aging and drying method of claim 1, wherein the first aging and the second aging each are conducted at a temperature of 20-50° C.

5. The aging and drying method of claim 1, wherein the drying is conducted at a temperature of 100-180° C. for 3-24 hours.

6. The aging and drying method of claim 1, further comprising, after the second aging, subjecting a resulting aged product to hydrophobic modification, and subjecting a resulting hydrophobic modified product to the drying to obtain a hydrophobic silica aerogel.

7. The aging and drying method of claim 6, wherein a reagent for the hydrophobic modification comprises one selected from the group consisting of trimethylchlorosilane and hexamethyldisilazane.

8. The aging and drying method of claim 6, wherein the hydrophobic modification comprises: immersing the resulting aged product in a hydrophobic modification reagent, and conducting the hydrophobic modification for 4-6 hours.

9. A silica aerogel fabricated by the aging and drying method of claim 1.

10. The aging and drying method of claim 2, wherein a thickness of the organic solvent protective layer is 5-15 mm higher than an upper surface of the wet gel.

11. The aging and drying method of claim 7, wherein the hydrophobic modification comprises: immersing the resulting aged product in a hydrophobic modification reagent, and conducting the hydrophobic modification for 4-6 hours.

12. The silica aerogel of claim 9, wherein an organic solvent in the organic solvent protective layer comprises one selected from the group consisting of ethanol and acetone.

13. The silica aerogel of claim 9, wherein a thickness of the organic solvent protective layer is 5-15 mm higher than an upper surface of the wet gel.

14. The silica aerogel of claim 9, wherein the first aging and the second aging each are conducted at a temperature of 20-50° C.

15. The silica aerogel of claim 9, wherein the drying is conducted at a temperature of 100-180° C. for 3-24 hours.

16. The silica aerogel of claim 9, further comprising, after the second aging, subjecting a resulting aged product to hydrophobic modification, and subjecting a resulting hydrophobic modified product to the drying to obtain a hydrophobic silica aerogel.

17. The silica aerogel of claim 16, wherein a reagent for the hydrophobic modification comprises one selected from the group consisting of trimethylchlorosilane and hexamethyldisilazane.

18. The silica aerogel of claim 16, wherein the hydrophobic modification comprises: immersing the resulting aged product in a hydrophobic modification reagent, and conducting the hydrophobic modification for 4-6 hours.

19. The silica aerogel of claim 12, wherein a thickness of the organic solvent protective layer is 5-15 mm higher than an upper surface of the wet gel.

20. The silica aerogel of claim 17, wherein the hydrophobic modification comprises: immersing the resulting aged product in a hydrophobic modification reagent, and conducting the hydrophobic modification for 4-6 hours.
